(19) United States
(12) Patent Application Publication
(10) Pub. No.: US 2013/0082815 A1
(43) Pub. Date: Apr. 4, 2013

(54) SOFT MAGNETIC ALLOY ELEMENT AND ELECTRONIC COMPONENT USING THE SAME

(71) Applicant: TAIYO YUDEN CO., LTD., Tokyo (JP)

(72) Inventor: Hideki OGAWA, Takasaki-shi (JP)

(73) Assignee: TAIYO YUDEN CO., LTD., Tokyo (JP)

(21) Appl. No.: 13/627,836

(22) Filed: Sep. 26, 2012

(30) Foreign Application Priority Data
Sep. 29, 2011 (JP) 2011-215185

(51) Int. Cl. H01F 27/255; H01F 1/00

(52) U.S. Cl. 336/233; 252/62.51 R

(57) ABSTRACT

A soft magnetic alloy element of high magnetic permeability that allows for easy quality check is constituted by a grain compact including: multiple metal grains 11 constituted by a Fe—Cr—Si soft magnetic alloy; oxide films formed on the surface of the metal grains; and connection parts via the oxide films formed on the surface of adjacent metal grains; wherein, in color difference measurement on the grain compact 1 based on the L*a*b* color system, a* (D65) is −3 to 5 and b* (D65) is −8 to 0, and preferably L* (D65) is 22 to 35, as well as an electronic component having such element.

### BACKGROUND

1. Field of the Invention

The present invention relates to a soft magnetic alloy element that can be used primarily for cores of coil inductors, etc., as well as an electronic component using such element.

2. Description of the Related Art

Coil components (so-called inductance components), such as inductors, choke coils, and transformers, all have a soft magnetic alloy element and conductive wires formed inside or on the surface of the soft magnetic alloy element. Ni—Cu—Zn ferrite or other ferrite is generally used as the material for this soft magnetic alloy element.

In recent years the market has been demanding larger current (higher rated current) for these types of coil components and, to meet this demand, products like metal composite inductors using a composite resin that contains soft magnetic powder as a magnetic body are already available on the market. These inductors are each given a specific shape by means of high-pressure molding of a composite magnetic material (composite magnetic powder) in which a winding coil is inserted.

Patent Literature 1 proposes a compact, slim inductor structure that combines a sintered core and composite resin, with a coil inserted inside. To be specific, a powder material containing a metal magnetic material of high magnetic saturation is compression-molded to form a core beforehand, after which a coil is inserted into this core and then a composite magnetic material is placed on top as an outer sheath to form a specific shape. In addition to the above, products having a structure where a pelletized powder of similar metal magnetic material is used and a coil is directly inserted, or specifically, metal composite inductors, are also available on the market.

Patent Literature 2 discloses a method to produce a magnetic body of a stacked coil component, whereby magnetic layers formed with a magnetic paste containing Fe—Cr—Si alloy grains and glass component are stacked with conductor patterns and then the stack is sintered in nitrogen atmosphere (reducing atmosphere), after which the sintered stack is impregnated with a thermosetting resin.

### BACKGROUND ART

| | |
|---|---|
| [Patent Literature 1] | Japanese Patent Laid-open No. 2010-34102 |
| [Patent Literature 2] | Japanese Patent Laid-open No. 2007-27354 |

### SUMMARY

However, inductors according to prior arts cannot achieve high magnetic permeability and high insulation resistance at the same time, which prevents direct installation of external electrodes on a core or outer sheath. As a result, external electrodes must be formed as part of the frame or by some other means, which puts design limitations on how much the current can be increased or the size can be reduced. To solve these problems, the inventor of the present invention consistently proposed an inductor structure whereby a hollow coil is inserted in a heat-treated metal magnetic powder core and then a magnetic powder composite material is placed on an outer sheath. Here, a Fe—Cr—Si alloy was used as the heat-treated metal magnetic core, and the alloy was treated in atmosphere at a specified peak temperature over a specified heat treatment time to generate a metal oxide layer between metal powders in a core, and thereby form a core. Through the trials done by the inventor, however, it was found that the magnetic characteristics of the core thus formed would take maximum values depending on the temperature and time conditions and that the characteristics must therefore be checked and evaluated for each set of heat treatment conditions using a dummy core.

In consideration of the above, the object of the present invention is to provide an alloy element of high magnetic permeability that allows for easy quality check, as well as an electronic component using such element.

Any discussion of problems and solutions involved in the related art has been included in this disclosure solely for the purposes of providing a context for the present invention, and should not be taken as an admission that any or all of the discussion were known at the time the invention was made.

After studying in earnest, the inventor completed the present invention described below.

The present invention relates to a soft magnetic alloy element constituted by a grain compact formed by specific metal grains in a specified mode, as well as an electronic component using such element. The grain compact has: multiple metal grains constituted by a Fe—Cr—Si soft magnetic alloy; oxide films formed on the surface of the metal grains; and connection parts via the oxide films formed on the surface of adjacent metal grains. When color difference is measured on the grain compact based on the L*a*b* color system, a* (D65) is −3 to 5 and b* (D65) is −8 to 0, and preferably L* (D65) is 22 to 35.

An alloy element of high magnetic permeability is provided by the present invention. The color of the heat-treated grain compact allows for judgment that a material of high magnetic permeability has been obtained, which makes it easy to determine good products in the manufacturing process. In other words, there is no longer a need to evaluate the characteristics of the electronic component in the final product form, or form a dummy core and put a winding wire on it to evaluate the characteristics, in order to determine whether or not the alloy element is good.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic section view of a fine structure of a soft magnetic alloy element conforming to the present invention.

FIG. 2 is a graph showing the relationship of the heat treatment temperature used to obtain a grain compact on one hand, and magnetic permeability of the obtained grain compact on the other.

### DESCRIPTION OF SYMBOLS

1: Grain compact
11: Metal grain
12: Oxide film
21: Direct connection part of metal grains
22: Connection part via oxide film
30: Void

### DETAILED DESCRIPTION OF EMBODIMENTS

The present invention is described in detail by referring to the drawings as necessary. Note, however, that the present invention is not at all limited to the illustrated embodiment and that, because the characteristic parts of the invention may be emphasized in the drawings, the scale of each part of the drawings is not necessarily accurate.

According to the present invention, the soft magnetic alloy element is constituted by a grain compact formed by specific metal grains. Under the present invention, the soft magnetic alloy element plays the role of a magnetic path in a coil inductor or other electronic component, and typically takes the form of a core of a coil component, etc.

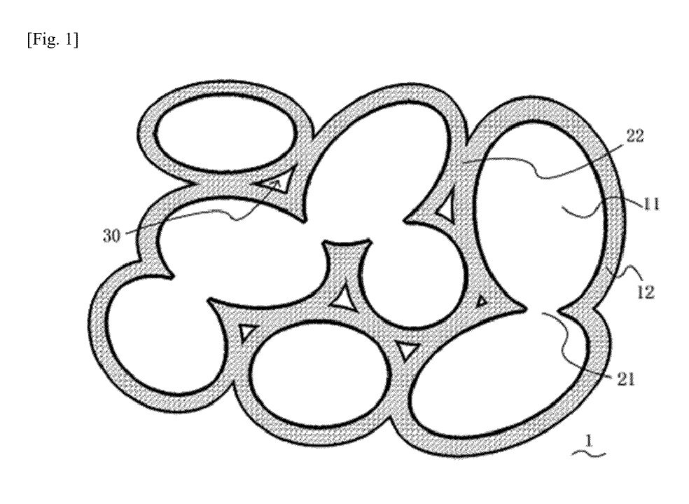

FIG. 1 is a schematic section view of a fine structure of a soft magnetic alloy element conforming to the present invention. Under the present invention, a grain compact 1 is understood microscopically as an aggregate of many originally independent metal grains 11 that are connected together. Each metal grain 11 has an oxide film 12 formed roughly all around it, and this oxide film 12 ensures the insulation property of the grain compact 1. The adjacent metal grains 11 are connected together primarily via the oxide films 12 around them, to constitute a grain compact 1 having a specific shape. Partially there may be direct connection parts 21 of the metal parts of adjacent metal grains 11. Traditional soft magnetic alloy elements used a hardened organic resin matrix in which independent magnetic grains or conjugates each comprising several or so magnetic grains were dispersed, or a hardened glass component matrix in which independent magnetic grains or conjugates each comprising several or so magnetic grains were dispersed. Under the present invention, on the other hand, preferably there is virtually no organic resin matrix or glass component matrix in the grain compact 1.

According to the present invention, the grain compact 1 is characterized by its color difference. The color difference is quantified by the color difference measurement based on the L*a*b* color system defined in JIS Z 8729. Measurement apparatuses are available on the market, and the color difference meter CR-300 (by Konica Minolta) can be used, for example. In this case, Ø11 mm can be selected for the irradiation diameter of the measurement head, for example. Any such measurement apparatus is used to measure an area of approx. 70 to 80 mm² on the surface of the measurement sample to obtain a* (D65), b* (D65) and L* (D65). The greater the measured value of a* (D65), the more reddish the color appears; the smaller the value, the more greenish the color appears. Also, the greater the measured value of b* (D65), the more yellowish the color appears; the smaller the value, the more bluish the color appears. Furthermore, the greater the measured value of L* (D65), the brighter the color appears; the smaller the value, the darker the color appears.

Under the present invention, a* (D65) is −3 to 5 and b* (D65) is −8 to 0, and preferably L* (D65) is 22 to 35, as measured above. The inventor of the present invention found, through numerous test results, that a soft magnetic alloy element of high magnetic permeability would be obtained in the above ranges. Under a favorable embodiment, c* is 3.6 to 8.0. Here, c* is a square root of the sum of a square of a* (D65) and square of b* (D65).

The oxide film 12 formed roughly all around the individual metal grain 11 may be formed in the material grain stage before the grain compact 1 is formed. Alternatively, a material grain having no oxide film or very little oxide film on it may be used, with an oxide film formed in the molding process. Presence of oxide film 12 can be recognized as a contrast difference on an image of around 3,000 magnifications taken by a scanning electron microscope (SEM). Insulation property of the soft magnetic alloy element as a whole can be ensured by the presence of oxide film 12.

In the grain compact 1, grains are primarily connected together by connection parts 22 via oxide film 12. Presence of connection parts 22 via oxide film 12 can be clearly determined by, for example, taking an enlarged SEM image, etc., of approx. 3,000 magnifications and visually confirming that the oxide films 12 of adjacent metal grains 11 have an identical phase. Presence of connection parts 22 via oxide film 12 improves the mechanical strength and insulation property.

According to the present invention, preferably adjacent metal grains 11 are connected together via their oxide films 12 throughout the grain compact 1, but as long as they are partially connected this way, reasonable improvement can be expected in mechanical strength and insulation property and such mode is also an embodiment of the present invention. Preferably the number of connection parts 22 via oxide film 12 is the same as or greater than the number of metal grains 11 contained in the grain compact 1. Also, partially there may be direct connection parts 21 of metal grains 11 where no oxide film is present, instead of connections via oxide film 12. “Direct connection parts of metal grains where no oxide film is present” are parts where adjacent metal grains 11 are directly contacting each other through their respective metal parts, where the concept encompasses a metal bond in a strict sense, embodiment where metal parts are directly contacting each other without permitting exchange of atoms, or embodiment in between, for example. Furthermore, a mode may be partially found where adjacent metal grains 11 are simply contacting or close to each other physically without having any connection part via oxide film 12 or direct connection part of metal grains 11.

Ways to form connection parts 22 of oxide films 12 include, for example, applying heat treatment to the grain compact 1 when it is manufactured, in an oxygen atmosphere (such as air) at a specified temperature as mentioned later.

Ways to confirm presence of the aforementioned direct connection parts 21 of metal grains include, for example, taking an enlarged SEM image, etc., of approx. 3,000 magnifications and visually confirming that adjacent metal grains 11 have connection points while maintaining an identical phase. Presence of direct connection parts 21 of metal grains improves the magnetic permeability further.

Ways to generate direct connection parts 21 of metal grains include, for example, using material grains having little oxide film on them, adjusting as described later the temperature and partial pressure of oxygen of the heat treatment applied to manufacture the grain compact 1, and adjusting the molding density when the grain compact 1 is obtained from material grains.

Individual metal grains 11 are primarily constituted by a specific soft magnetic alloy. Under the present invention, metal grains 11 are made of a Fe—Cr—Si soft magnetic alloy.

The Si content of the Fe—Cr—Si soft magnetic alloy is preferably 0.5 to 7.0 percent by weight, or more preferably 2.0 to 5.0 percent by weight. These ranges are based on the fact that a higher Si content is preferred in that it leads to high resistance and high magnetic permeability, while a lower Si content leads to good moldability.

The Cr content of the Fe—Cr—Si soft magnetic alloy is preferably 2.0 to 15 percent by weight, or more preferably 3.0 to 6.0 percent by weight. While presence of Cr causes the magnetic characteristics of the material grain before heat treatment to drop, it suppresses excessive oxidization during heat treatment. Therefore, more Cr means that the magnetic permeability rises more effectively through heat treatment and that the specific resistance becomes lower after heat treatment. The above preferable ranges are proposed in consideration of the foregoing.

The remainder of the Fe—Cr—Si soft magnetic alloy other than Si and Cr is preferably Fe, except for unavoidable impurities. Metals that may be contained other than Fe, Si and Cr include manganese, aluminum, cobalt, nickel and copper, among others.

The chemical composition of the alloy constituting each metal grain 11 of the grain compact 1 can be calculated, for example, by taking an image of the section of the grain compact 1 using a scanning electron microscope (SEM) and then analyzing the image by energy dispersive X-ray spectroscopy (EDS) based on the ZAF method.

The mol ratio of Cr and Fe (Cr/Fe) in the oxide film 12 is preferably 1.0 to 5.0. As with the alloy, the chemical composition of the oxide film 12 can also be calculated by taking an image of the section of the grain compact 1 using a scanning electron microscope (SEM) and then analyzing the image by energy dispersive X-ray spectroscopy (EDS) based on the ZAF method.

The size of the individual material grain is virtually equivalent to the size of the metal grain constituting the grain compact 1 of the soft magnetic alloy element as finally obtained. The size of the material grain is preferably a d50 of 2 to 30 μm, or more preferably 2 to 20 μm, or yet more preferably 3 to 13 μm, when the magnetic permeability and eddy current loss in the grain are considered. The d50 of the material grain can be measured using a laser diffraction/scattering measurement apparatus.

The material grain may be manufactured by the atomization method, for example. As mentioned above, when forming connection parts 22 via oxide film 12 in the grain compact 1, preferably parts that were metal in the material grain stage are oxidized by heat treatment. To this end, oxide film may be present, but not excessively, on the material grain. Means for reducing the oxide film of the material grain include, for example, heat-treating the material grain in a reducing atmosphere or applying a chemical treatment such as acid removal of the surface oxide layer.

The aforementioned material grain may be manufactured by any known alloy grain manufacturing method, or any commercially available product may be used such as PF20-F by Epson Atmix or SFR-FeSiAl by Nippon Atomized Metal Powders.

The method to obtain a molding from material grains is not specifically limited, and any known grain compact manufacturing means can be incorporated as deemed appropriate. The following explains a typical example of manufacturing where material grains are molded without heat and then given heat treatment.

When molding material grains without heat, preferably an organic resin is added as a binder. For the organic resin, use of acrylic resin, butyral resin, vinyl resin or other resin whose thermal decomposition temperature is 500° C. or below is preferable because not much binder will remain after heat treatment. Any known lubricant may be added during molding. The lubricant may be an organic acid salt, or specifically zinc stearate or calcium stearate. The amount of lubricant is preferably 0 to 1.5 parts by weight, or more preferably 0.1 to 1.0 part by weight, relative to 100 parts by weight of material grains. The amount of lubricant of “0” means that no lubricant is used. Material grains are agitated with a binder and/or lubricant added as desired, and then formed to a desired shape. Molding is performed under pressure or other conditions so that the apparent density of the molding becomes preferably 5.5 to 7.0 g/cm³.

A favorable embodiment of heat treatment is explained.

Preferably heat treatment is performed in an oxidizing atmosphere. To be specific, the oxygen concentration during heat is preferably 1% or more, as it facilitates generation of both connection parts 22 via oxide film and direct connection parts 21 of metal grains. There is no specific maximum limit of oxygen concentration, but a representative oxygen concentration is that in air (approx. 21%) in consideration of manufacturing cost, etc. Preferably the heating temperature is 600° C. or above, but to suppress oxidization at an appropriate level to maintain presence of direct connection parts of metal grains for higher magnetic permeability, preferably the heating temperature is 900° C. or below. More preferably the heating temperature is 700 to 800° C. Preferably the heating time is 0.5 to 3 hours.

The obtained grain compact 1 may have voids 30 inside. Voids 30 present inside the grain compact 1 may be partially impregnated with a polymer resin (not illustrated). Means for impregnating a polymer resin include, for example, soaking the grain compact 1 in a liquid polymer resin such as a polymer resin in liquid state or solution of polymer resin, and then lowering the manufacturing pressure, or applying the above liquid polymer resin on the grain compact 1 to have it permeate into the voids 30 near the surface. Impregnating a polymer resin into voids 30 in the grain compact 1 provides the advantage of increasing strength and suppressing hygroscopicity. The polymer resin is not specifically limited and it can be epoxy resin, fluororesin or other organic resin, silicone resin, etc.

As another method for manufacturing an electronic component using a soft magnetic alloy element conforming to the present invention, a manufacturing method where the electronic component is a stacked inductor is explained as an example. First, a prepared magnetic paste (slurry) is applied on the surface of a base film made of resin, etc., using a doctor blade, die-coater or other coating machine. The coated film is dried using a hot-air dryer or other dryer to obtain a green sheet. The above magnetic paste contains metal grains 11 and, typically, a polymer resin as a binder and solvent.

Preferably the magnetic paste contains a polymer resin as a binder. The type of polymer resin is not specifically limited, and it may be polyvinyl butyral (PVB) or other polyvinyl acetal resin. The type of solvent for the magnetic paste is not specifically limited, and butyl carbitol or other glycol ether may be used, for example. The blending ratio of soft magnetic alloy grains, polymer resin, solvent, etc., for the magnetic paste can be adjusted as deemed appropriate, and a desired viscosity or other property of the magnetic paste can be set by adjusting this ratio.

The specific method to apply and dry the magnetic paste to obtain a green sheet may use any prior art as deemed appropriate. The green sheet may be rolled. Rolling can use a calender roll, roll press, etc. Rolling is performed by applying a pressure of 1800 kgf or more, for example, where the pressure is preferably 2000 kgf or more, or more preferably 2000 to 8000 kgf, at 60° C. or above, for example, or preferably 60 to 90° C.

Next, a stamping machine, laser processing machine or other punching machine is used to punch the green sheet to form through holes in a specified arrangement. The arrangement of through holes is set in such a way that, when the sheets are stacked together, conductor-filled through holes and conductor patterns will form a coil. The arrangement of through holes and the shape of conductor patterns for forming a coil may use any prior art as deemed appropriate.

Preferably a conductive paste is used to fill the through holes and print the conductor patterns. The conductive paste contains conductive grains and, typically, a polymer resin as a binder and solvent.

For the conductive grains, silver grains, etc., may be used. Preferably the size of the conductive grain is a d50 of 1 to 10 μm by volume standard. The d50 of the conductive grain is measured using a grain size/granularity distribution measurement apparatus based on the laser diffraction/scattering method (such as Microtrack by Nikkiso).

Preferably the conductive paste contains a polymer resin as a binder. The type of polymer resin is not specifically limited, and it may be polyvinyl butyral (PVB) or other polyvinyl acetal resin. The type of solvent for the conductive paste is not specifically limited, and butyl carbitol or other glycol ether may be used, for example. The blending ratio of conductive grains, polymer resin, solvent, etc., for the conductive paste can be adjusted as deemed appropriate, and a desired viscosity or other property of the conductive paste can be set by adjusting this ratio.

Next, the conductive paste is printed on the surface of the green sheet using a screen printer, gravure printer, or other printing machine, after which the printed sheet is dried using a hot-air dryer or other dryer to form conductor patterns corresponding to a coil, etc. The aforementioned through holes are partially filled with the conductive paste during printing. As a result, the conductive paste filled in the through holes, and printed conductor patterns, together constitute the shape of a coil, etc.

Green sheets thus printed are stacked in a specified sequence and then thermally compressed using a pickup transfer machine and press machine to produce a stack. Next, a dicing machine, laser processing machine or other cutting machine is used to cut the stack to the size of the component to produce a chip before heat treatment.

A sintering oven or other heating apparatus is used to heat the chip before heat treatment in atmosphere or other oxidizing atmosphere. This heat treatment normally includes a binder removal process and oxide film-forming process, where the binder removal process is performed, for example, under conditions of approx. 300° C. being a temperature at which the polymer resin binder disappears, for approx. 1 hour. The oxide film forming process is performed under conditions of approx. 750° C. for approx. 2 hours, for example.

In the chip before heat treatment, many fine gaps are present between individual metal grains 11 and these fine gaps are normally filled with a mixture of solvent and binder. This mixture disappears in the binder removal process, and by the time the binder removal process is complete, these fine gaps have turned into pores. In the chip before heat treatment, many fine gaps are also present between conductive grains. These fine gaps are filled with a mixture of solvent and binder. This mixture also disappears in the binder removal process.

In the oxide film-forming process following the binder removal process, alloy grains 11 gather close together to form a grain compact 1, during which process, typically, connection parts 22 via oxide films 12 on the surface of respective alloy grains 11 are formed. These connection parts 22 are at least partially formed by a crystalline oxide and preferably continuously lattice-bonded. At the same time, conductive grains are sintered and conductive wires for a coil, etc., are formed. As a result, a stacked inductor is obtained.

Normally external terminals are formed after heat treatment. A dip coater, roller coater or other coating machine is used to apply a prepared conductive paste on both longitudinal ends of the component, after which the coated component is baked using a sintering oven or other heating apparatus under conditions of approx. 600° C. for approximately 1 hour, for example, to form external terminals. For the conductive paste for external terminals, the aforementioned paste for printing conductor patterns or similar paste can be used as deemed appropriate.

A soft magnetic alloy element constituted by the grain compact 1 thus obtained can be used as a constituent of various electronic components. For example, a soft magnetic alloy element conforming to the present invention can be used as a core, with conductive wires with insulating coating wrapped around the core to form a coil component or other electronic component. In addition, a soft magnetic alloy element conforming to the present invention can be used, with conductive wires formed inside or on the surface, to obtain various electronic components. The aforementioned stacked inductor is also an embodiment of such electronic component. Electronic components of various mounting modes such as the surface mounting type and through-hole mounting type are possible, and the means for obtaining an electronic component from a soft magnetic alloy element, including the means for constituting an electronic component of any such mounting mode, can use any known manufacturing method employed in the field of electronic components. The conductive wires are not limited to those of a helical coil, but they may be a spiral coil, meandering conductive wire, or straight conductive wire, for example.

### EXAMPLES

The present invention is explained more specifically below using examples. Note, however, that the present invention is not at all limited to the embodiments described in these examples.

(Material Grain)

A commercial Fe—Cr—Si alloy powder was used as the material grain. The composition of the alloy powder was calculated by the ZAF method based on energy dispersive X-ray spectroscopy (EDS). The d50 of the alloy powder was measured using a laser diffraction/scattering measurement apparatus as an indicator of grain size distribution by volume standard. The commercial alloy powder was used directly as the material grain.

(Manufacturing of Grain compact)

One hundred parts by weight of material grains were mixed under agitation with 1.5 parts by weight of a PVA binder of 300° C. in thermal decomposition temperature, and the mixture was pelletized. Thereafter, the pellets were pressed into a T-shaped core with an apparent density of 6.3 g/cm³, and then the core was heat-treated for 2 hours at a specified temperature in an oxidizing atmosphere of 21% in oxygen concentration. The binder was removed through this heat treatment and a grain compact was obtained. An enlarged SEM image of 3,000 magnifications found that the oxide films formed on the surface of adjacent metal grains in the obtained grain compact had an identical phase.

(Manufacturing of Electronic Component)

A coil component having the aforementioned grain compact as its core was manufactured. A sintering electrode paste was applied on the flange of the core constituted by the grain compact, and the core was sintered in atmosphere at 650° C. to form electrodes, thereby obtaining a coil component being an electronic component.

(Color Difference Measurement of Grain compact)

Color difference was measured on the surface of the grain compact as follows:

Measurement apparatus: Color difference meter CR-300 (by Konica Minolta)

Irradiation diameter of measurement head: Ø11 mm

Area of measurement sample: 70 to 80 mm²

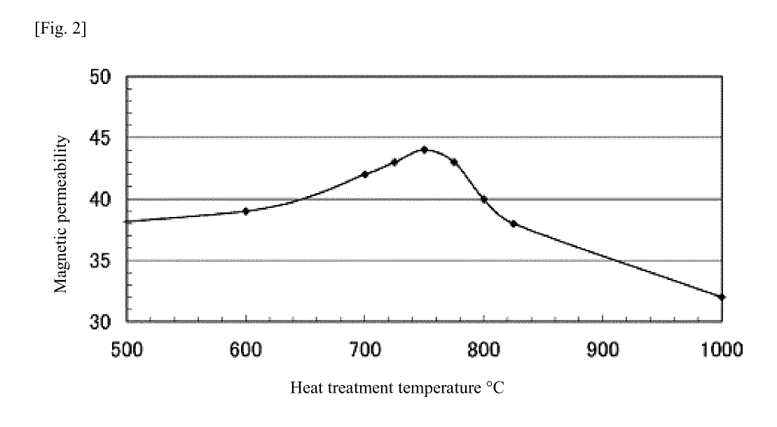

FIG. 2 is a graph showing the relationship of the heat treatment temperature used to obtain a grain compact on one hand, and magnetic permeability of the obtained grain compact on the other. The material used here is a Fe—Cr—Si soft magnetic alloy grain with a d50 of 10 μm, containing 4.5 percent by weight of Cr, 3.5 percent by weight of Si, and Fe for the remainder. The values of a* (D65), b* (D65) and L* (D65) of eight samples plotted in FIG. 2 are listed below. The samples are numbered 1, 2, . . . , etc., from the one of the lowest heat treatment temperature:

Sample 1: a* (D65)=6.32, b* (D65)=9.74, L* (D65)=33.07

Sample 2: a* (D65)=3.65, b* (D65)=−2.33, L* (D65)=26.79

Sample 3: a* (D65)=1.48, b* (D65)=−6.46, L* (D65)=28.14

Sample 4: a* (D65)=0.13, b* (D65)=−5.92, L* (D65)=30.66

Sample 5: a* (D65)=3.37, b* (D65)=−6.50, L* (D65)=24.00

Sample 6: a* (D65)=0.37, b* (D65)=1.37, L* (D65)=39.00

Sample 7: a* (D65)=−0.17, b* (D65)=2.88, L* (D65)=43.67

Sample 8: a* (D65)=3.68, b* (D65)=5.30, L* (D65)=38.43

More samples were produced to study the relationship of the measured color difference on the surface, and magnetic permeability, of the grain compact. As shown in Table 1 below, samples of varying a* (D65), b* (D65) and L* (D65) were produced from the Fe—Cr—Si soft magnetic alloy grain with a d50 of 10 μm by means such as changing its heat treatment temperature, and the relationships of corresponding a* (D65), b* (D65) and L* (D65) and magnetic permeability were summarized. In the table, c* is a square root of the sum of a square of a* (D65) and square of b* (D65). The sample numbers in the table are different from the sample numbers used in the explanation of FIG. 2 above. Samples corresponding to an example of the present invention have an asterisk (*) after their number.

TABLE 1

| Sample | | | | | Magnetic |
|---|---|---|---|---|---|
| number | a*(D65) | b*(D65) | L*(D65) | C* | permeability |
| 1 | 7.09 | 11.25 | 41.83 | 13.30 | 37.2 |
| 2 | 7.09 | 11.23 | 41.89 | 13.28 | 37.5 |
| 3 | 5.32 | 10.30 | 34.84 | 11.59 | 38.5 |
| 4 | 5.41 | 10.24 | 34.80 | 11.58 | 38.7 |
| 5 | 6.23 | 9.73 | 33.11 | 11.55 | 38.4 |
| 6 | 6.32 | 9.74 | 33.07 | 11.61 | 38.8 |
| 7 | 4.45 | 11.62 | 38.16 | 12.44 | 38.6 |
| 8 | 4.46 | 11.64 | 38.22 | 12.47 | 38.5 |
| 9 | 4.25 | 9.30 | 42.67 | 10.23 | 39.4 |
| 10 | 5.11 | 9.48 | 41.07 | 10.77 | 39.3 |
| 11 | 4.91 | 9.69 | 41.22 | 10.86 | 39.4 |
| 12 | 7.20 | 3.12 | 18.87 | 7.85 | 40.3 |
| 13 | 7.33 | 3.12 | 18.44 | 7.97 | 40.1 |
| 14 | 6.00 | 2.66 | 17.30 | 6.56 | 41.4 |
| 15 | 5.70 | 2.69 | 16.26 | 6.30 | 41.4 |
| 16 | 5.57 | 1.93 | 17.12 | 5.89 | 41.3 |
| 17* | 3.52 | −2.29 | 26.76 | 4.20 | 42.3 |
| 18* | 3.65 | −2.33 | 26.79 | 4.33 | 42.2 |
| 19* | 4.23 | −2.48 | 24.89 | 4.90 | 42.2 |
| 20* | 4.23 | −2.52 | 24.89 | 4.92 | 42.4 |
| 21* | 1.48 | −6.46 | 28.14 | 6.63 | 43.2 |
| 22* | 1.48 | −6.42 | 28.14 | 6.59 | 43.1 |
| 23* | 0.95 | −4.81 | 31.56 | 4.90 | 43.3 |
| 24* | 0.94 | −4.86 | 31.49 | 4.95 | 43.4 |
| 25* | −0.15 | −1.89 | 37.35 | 1.90 | 43.6 |
| 26* | −0.15 | −1.89 | 37.34 | 1.90 | 44.2 |
| 27* | −0.19 | −4.37 | 33.31 | 4.37 | 44.3 |
| 28* | −0.19 | −4.34 | 33.33 | 4.34 | 43.8 |
| 29* | 0.07 | −0.94 | 36.84 | 0.94 | 43.8 |
| 30* | 0.07 | −0.96 | 36.86 | 0.96 | 43.6 |
| 31* | 0.13 | −5.92 | 30.66 | 5.92 | 43.9 |
| 32* | 0.03 | −5.92 | 30.66 | 5.92 | 43.8 |
| 33* | −0.03 | −6.58 | 30.90 | 6.58 | 44.2 |
| 34* | 0.08 | −6.61 | 30.90 | 6.61 | 44.1 |
| 35* | 3.37 | −6.50 | 24.00 | 7.32 | 42.8 |
| 36* | 3.51 | −6.53 | 23.93 | 7.41 | 42.9 |
| 37* | 2.02 | −7.78 | 25.71 | 8.04 | 42.8 |
| 38* | 2.03 | −7.94 | 25.86 | 8.20 | 42.9 |
| 39* | 0.13 | −5.92 | 30.66 | 5.92 | 42.8 |
| 40* | 0.03 | −5.92 | 30.66 | 5.92 | 42.9 |
| 41* | −0.03 | −6.58 | 30.90 | 6.58 | 42.7 |
| 42* | 0.08 | −6.61 | 30.90 | 6.61 | 42.8 |
| 43* | −0.51 | −1.29 | 31.08 | 1.39 | 43.1 |
| 44* | −0.52 | −1.35 | 30.97 | 1.45 | 43.2 |
| 45* | −0.42 | −1.23 | 31.53 | 1.30 | 42.9 |
| 46* | −0.84 | −2.16 | 30.23 | 2.32 | 43.1 |
| 47* | −1.27 | −1.76 | 32.26 | 2.17 | 43.2 |
| 48* | −1.09 | −1.96 | 31.08 | 2.24 | 43.3 |
| 49* | −1.09 | −2.01 | 31.00 | 2.29 | 43.2 |
| 50 | 0.37 | 1.37 | 39.00 | 1.42 | 40.1 |
| 51 | 0.43 | 1.37 | 38.92 | 1.44 | 40.2 |
| 52 | −0.17 | 2.88 | 43.67 | 2.89 | 38.2 |
| 53 | −0.05 | 2.90 | 43.64 | 2.90 | 38.5 |
| 54 | −0.14 | 2.92 | 43.52 | 2.92 | 38.4 |
| 55 | 4.23 | 4.34 | 38.38 | 6.06 | 35.7 |
| 56 | 4.23 | 4.34 | 38.38 | 6.06 | 35.6 |
| 57 | 3.59 | 5.04 | 38.41 | 6.19 | 34.2 |
| 58 | 3.77 | 5.00 | 39.01 | 6.26 | 33.2 |
| 59 | 3.28 | 4.85 | 38.84 | 5.85 | 32.1 |
| 60 | 3.68 | 5.30 | 38.43 | 6.45 | 32.2 |

As shown in Table 1, there is a good correlation between magnetic permeability on one hand, and values of a* (D65) and b* (D65) on the other. When a* (D65) is −3 to 5 and b* (D65) is −8 to 0, the magnetic permeability can be 42.0 or higher.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2011-215185, filed Sep. 29, 2011, the disclosure of which is incorporated herein by reference in its entirety. In some embodiments, as the grain compact and its production processes, those disclosed in co-assigned U.S. patent application Ser. No. 13/313,999, and U.S. Patent Application Publication No. 2012/0188049, No. 2012/0038449, and No. 2011/0267167 can be used, each disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A soft magnetic alloy element constituted by a grain compact comprising:
multiple metal grains constituted by a Fe—Cr—Si soft magnetic alloy; oxide films formed on a surface of the metal grains; and connection parts via the oxide films formed on the surface of adjacent metal grains; wherein, in color difference measurement on the grain compact based on the L*a*b* color system, a* (D65) is −3 to 5 and b* (D65) is −8 to 0.

2. A soft magnetic alloy element according to claim 1, wherein, in color difference measurement on the grain compact based on the L*a*b* color system, L* (D65) is 22 to 35.

3. A soft magnetic alloy element according to claim 1, wherein the grain compact has a magnetic permeability of 42.0 or higher.

4. An electronic component having a soft magnetic alloy element according to claim 1.

5. An electronic component having a soft magnetic alloy element according to claim 2.
